(19) United States
(12) Patent Application Publication
(10) Pub. No.: US 2012/0285566 A1
(43) Pub. Date: Nov. 15, 2012

(54) COMPRESSED FLUID VEHICLE

(76) Inventor: Henry Lemont Wienand, Lambert Bay (ZA)

(21) Appl. No.: 13/510,939

(22) PCT Filed: Nov. 18, 2010
(86) PCT No.: PCT/ZA10/00070

§ 371 Date: May 20, 2012

(30) Foreign Application Priority Data
Nov. 19, 2009 (ZA) 2009/08148

(51) Int. Cl. B60K 15/073

(52) U.S. Cl. 137/596; 220/586

(57) ABSTRACT

A compressed fluid storage arrangement (10) for a compressed fluid vehicle which includes a core of flexuous tubing (102) for storing compressed fluid to be supplied to a motor (70) of the vehicle, the core (102) being shaped and dimensioned to occupy a cavity of a vehicle component. The compressed fluid is delivered via a pressure control system (90) to the engine (70), which in turn generates an engine output.

This invention relates to a compressed fluid vehicle. More particularly, the invention relates to a compressed fluid storage arrangement of such a vehicle and a compressed fluid reticulation installation for storing compressed fluid in a vehicle.

The invention is expected to be particularly advantageously applicable to compressed air vehicles. Accordingly, such applications should particularly, but not exclusively, be borne in mind when considering this specification.

### BACKGROUND OF THE INVENTION

A compressed air vehicle uses a motor powered by compressed air and is either powered solely by air, or by a hybrid combination compressed air, fuel and regenerative braking. The compressed air is stored at high pressure (e.g. 300 bar) in a compressed air pressure vessel designed to hold the air at a pressure substantially different from the ambient pressure. An air pressure vessel (or tank) is subject to rupturing of the tank at high pressures and hence poses a safety risk of exploding. The amount of pressure that a vessel can withstand is related to the surface area of the vessel and hence places a limit on the size of the vessel if explosion of the vessel is to be prevented. As a result, a compressed air vehicle tank at about 300 bar of pressure is limited in capacity to hold between 200 and 300 litres of compressed air. Such air is conventionally stored in a single tank. To reduce the risk of explosion, such a tank may be a leak-before-burst type tank that is designed so that a crack in the tank will grow through the tank wall, allowing the contained air to escape (thereby reducing the pressure) prior to growing so large as to result in rupturing of the tank wall during operation. Storage tanks are thus often made of carbon-fiber for weight reduction while maintaining strength; if penetrated carbon fiber will crack but not produce shrapnel. Compressed air is also relatively space inefficient way of storing energy when compared to conventional gasoline due to the low pressure at which it can be stored. By illustration, air at 30 MPa (4,500 psi) contains about 50 Wh of energy per liter whereas gasoline contains about 9411 Wh per liter.

The inventor has identified a need for a mechanism whereby larger volumes of compressed air may be stored in a compressed air vehicle whilst maintaining safety of storage and use of the compressed air. Further it would be preferable for a compressed air vehicle to have a plurality of isolated storage areas to prevent the entire installation being compromised in the event of a malfunction in a single storage area. Still further, it would be preferable for the storage installation to be located in the vehicle by utilising non-usable space without intruding into the usable space of the vehicle. The invention seeks to at least partially ameliorate the disadvantageous associated with the prior art.

### SUMMARY OF THE INVENTION

In accordance with the invention broadly, there is provided a compressed fluid storage arrangement of a compressed fluid vehicle which includes a core of flexuous tubing for holding compressed fluid to be supplied to a motor of the vehicle, the core being shaped and dimensioned to occupy a cavity of a vehicle component. The component may comprise a pre-existing cavity, alternately the component may have its internal contents replaced by the tubing thereby maintaining the external integrity of the component while increasing tubing volume in the vehicle. By illustration, the internal lining of a car seat may be partially replaced by the tubing. According to another broad aspect of the invention there is provided a compressed fluid storage arrangement of a compressed fluid vehicle, which includes any one or more of an interior compartment and a component of the motor vehicle manufactured of a porous material for storing compressed fluid to be supplied to an engine of the vehicle.

More particularly and according to one aspect of the invention there is provided a compressed fluid storage arrangement of a compressed fluid motor vehicle, which includes:

a core of flexuous tubing for holding compressed fluid to be supplied to a motor of the motor vehicle, the core being shaped and dimensioned to occupy an interior of a compartment, or component, or both of a vehicle, the tubing having a high surface area relative to the volume of the tubing;

at least an end of the tubing defining a first opening for fluidly connecting the core to a compressed fluid supply line of an engine of the motor vehicle for permitting introduction of compressed fluid into the core, or permitting delivery of compressed fluid to the engine, or both.

A compartment of a vehicle may include, but is not limited to, any one or more of: a passenger compartment; a luggage compartment; and an engine compartment. A component of the vehicle may include, but is not limited to, any one or more of: a body part such as a roof, a boot lid, or an engine bonnet; a seat; a chassis; and a door. It should be appreciated that ideally, the storage arrangement may be located in the vehicle being powered by the compressed fluid in use, however, the storage arrangement may also be located in a secondary vehicle, such as a trailer being towed by the vehicle being powered by the compressed fluid.

The arrangement may include a fluid pressure control system for controlling the fluid pressure of the core of flexuous tubing, the fluid pressure control system having a minimum fluid pressure level and a maximum fluid pressure level, the system being configured, in use, to automatically permit inlet fluid flow into the core via the first opening until the maximum pressure level is reached, whereafter the inlet fluid flow is terminated, and to automatically permit delivery of compressed fluid via the first opening to the motor of the compressed fluid vehicle until the minimum pressure level is reached.

To this end, the fluid pressure control system may include control means mounted at the first opening for controlling fluid flow into the flexuous tubing of the core. The control means may include a control valve, such as a solenoid valve, for controlling inlet fluid flow and outlet fluid flow to and from the tubing of the core.

Naturally, the first opening may be provided with a connector mounted at the at least one end of the tubing for connecting the arrangement to the compressed fluid supply line of the engine. The supply line may be provided with a re-fuelling connector for connecting the supply line to an external compressor whereby, in use, the compressor would fill the arrangement with compressed fluid.

The arrangement may include a second opening defined by at least another end of the tubing for permitting introduction of compressed fluid to the core of the arrangement. In this embodiment of the invention, the second opening is configured to be an inlet opening for permitting compressed fluid flow into the tubing and the first opening is configured to be an outlet opening for permitting compressed fluid flow to the supply line of the engine of the motor vehicle.

Naturally, the second opening may be provided with a connector mounted at the other end of the tubing for connecting a compressed air supply to the arrangement. In this embodiment, the fluid pressure control system may be configured, in use, to permit inlet fluid flow into the core via the second opening until the maximum pressure level is reached, hereafter the inlet fluid flow is terminated, and to automatically permit delivery of compressed fluid via the first opening to the supply line of the engine of the motor vehicle until the minimum pressure is reached.

The control means may include inlet control means mounted at the second opening for controlling fluid flow into the flexuous tubing of the core. The control means may include outlet control means mounted at the first opening for controlling outlet fluid flow from the tubing of the core to the supply line of the engine.

In one embodiment, the second opening configured to be an inlet opening includes a re-fuelling connector for connecting the inlet opening to a compressor for filling the arrangement with compressed fluid. In this embodiment in use and prior to driving the compressed fluid vehicle, the arrangement is filled with compressed fluid by connecting a compressor to the second opening configured to be the inlet opening and filling the core until the maximum fluid pressure level is reached. In use and whilst driving the compressed fluid vehicle, the compressed fluid of the core is delivered to the engine via the first opening configured to be the outlet opening in fluid communication with the supply line to the engine until the minimum pressure level is reached.

Advantageously, the inlet opening and the outlet opening may be provided with a connector integral with both the inlet opening and the outlet opening and leading to the supply line of the engine, such as a T-piece connector.

Conveniently, the arrangement would include appropriate electrical circuitry connected to a power supply of the vehicle.

In one embodiment of the arrangement, the flexuous tubing may be of flexible nylon material. In another embodiment, a component of the vehicle may be of a porous material for storage of the compressed fluid. The tubing may be designed to leak before burst, such that when pressurised and upon excessive pressure, structural failure of the tubing walls would result in escaping of fluid to avoid bursting of the tubes.

It should be appreciated that the compressed fluid storage arrangement may be portable so that it may be conveniently removed from the vehicle for refilling, for example in the form of a carry-case type arrangement that may be placed on the seat or luggage compartment of the vehicle.

According to another aspect of the invention there is provided a compressed fluid reticulation installation for storing compressed fluid in a vehicle, the installation including:

two or more compressed fluid storage arrangements as hereinbefore described, the arrangements being installed in a vehicle and fluidly connected in parallel, or series, or both such that the connectors of the arrangements are fluidly connected to a compressed fluid supply line of an engine of a motor vehicle.

The compressed fluid reticulation installation may include a fluid pressure control system for controlling the fluid pressure of the cores of the two or more arrangements to automatically permit inlet fluid flow into the cores of the fluidly connected arrangements via the supply line of the engine until one or more maximum pressures within the arrangements are reached.

The pressure control system may be configured to allow delivery of pressurised fluid to the supply line of the engine until one or more minimum pressures within the arrangements are reached, i.e. until the pressurised fluid of any one or more of the arrangements is depleted.

The fluid pressure control system may include a programmable controller for controlling the fluid pressure in the two or more arrangements. The programmable controller may be operable to determine the fluid pressure in any one or more of the arrangements, and based on the fluid pressure in any one or more of the arrangements, effect the control means of the one or more arrangements to effect a continuous flow of pressurised fluid from the fluid reticulation installation to the engine of the vehicle. To this end, the programmable controller may be operable to scan the fluid pressure of the two or more arrangements in order to determine their respective fluid pressures.

The invention will now be described, by way of non-limiting example, with reference to the accompanying diagrammatic drawings:

### DRAWINGS

In the drawings:

FIG. 1 shows a schematic block diagram of a compressed fluid reticulation installation in accordance with one aspect of the invention;

FIG. 2 shows a schematic sectional side view and schematic sectional plan view of compressed fluid storage arrangements of a vehicle door and a vehicle chassis according to another aspect of the invention;

FIG. 3 shows a schematic sectional side view of a compressed fluid storage arrangement of a vehicle seat according to another aspect of the invention;

FIG. 4 shows a schematic sectional front view of a compressed fluid storage arrangement of a vehicle engine bonnet according to another aspect of the invention;

FIG. 5 shows a schematic block diagram of a compressed fluid reticulation installation being installed on a jet-type engine.

FIG. 6 shows a schematic cross section view of the compressed fluid storage arrangement of FIG. 2 according to another embodiment of the invention.

Unless otherwise indicated, like reference numerals denote like parts.

### EMBODIMENT OF THE INVENTION

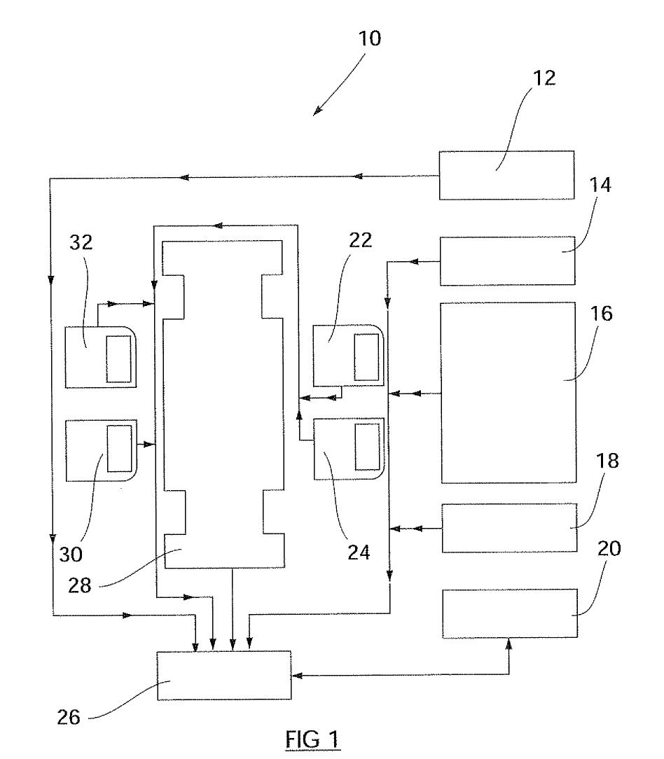

With reference to FIG. 1 of the drawings, reference numeral 10 generally designates a compressed fluid reticulation installation. The installation 10 includes several compressed fluid storage arrangements 12, 14, 16, 18, 20, 22, 24, 28, 32 and 30 shaped and dimensioned to either occupy an interior compartment of a vehicle, or component of a vehicle, or both (as will become more apparent hereunder) and each arrangement being fluidly connected and installed in a vehicle (not shown). In this embodiment, the compressed fluid vehicle is a compressed air car.

The arrangement 12 is shaped and dimensioned to take the shape and fill an interior of a rear passenger seat of the vehicle and is fluidly directly connected to a supply line in the form of a manifold 26 of an engine of the vehicle. Likewise, the arrangement 20 is shaped and dimensioned to take the shape and fill an interior of a front seat of the vehicle and is fluidly directly connected to the supply line in the form of the manifold 26. The arrangement 14 is shaped and dimensioned to make up a boot lid of the vehicle, the arrangements 16 shaped and dimensioned to fit within a roof of the vehicle and the arrangement 18 shaped and dimensioned to make up an engine bonnet of the vehicle, the arrangements 14, 16 and 18 being fluidly connected in parallel to supply the engine with compressed fluid, i.e. compressed air, via the manifold 26. Arrangements 22, 24, 30 and 32 make up the structures of four doors of the vehicle and are fluidly connected to the manifold 26. The arrangement 28 is located within and shaped and dimensioned to resemble the chassis of the vehicle and fluidly directly connected to the manifold 26.

The arrangements each have a core of flexuous nylon tubing (as can be seen clearly in FIG. 6) that hold compressed air to be supplied to the manifold 26 of the engine of the compressed air vehicle, the arrangements each having at least one end of their tubing defining a first opening fluidly connecting the cores of the arrangements 12, 14, 16, 18, 20, 22, 24, 30 and 32 to the supply line in the form of the manifold 26 of the engine for permitting introduction of the compressed fluid into each core and for permitting delivery of compressed fluid to the engine.

The arrangements of FIG. 1 each have control means mounted at the first opening for controlling fluid flow to and from the flexuous tubing of the arrangements in the form of solenoid valves.

The installation 10 includes a fluid pressure control system for controlling the air pressure of the cores of the arrangements to automatically permit inlet fluid flow into the cores of the connected arrangements via their connectors from a filler, such as a compressor, and to automatically permit delivery of compressed fluid via their outlet connectors to the manifold 26. To this end, the pressure control system includes a programmable logic controller (PLC) which, in use, scans the available pressure in the arrangements and effects their control means to source air pressure where available.

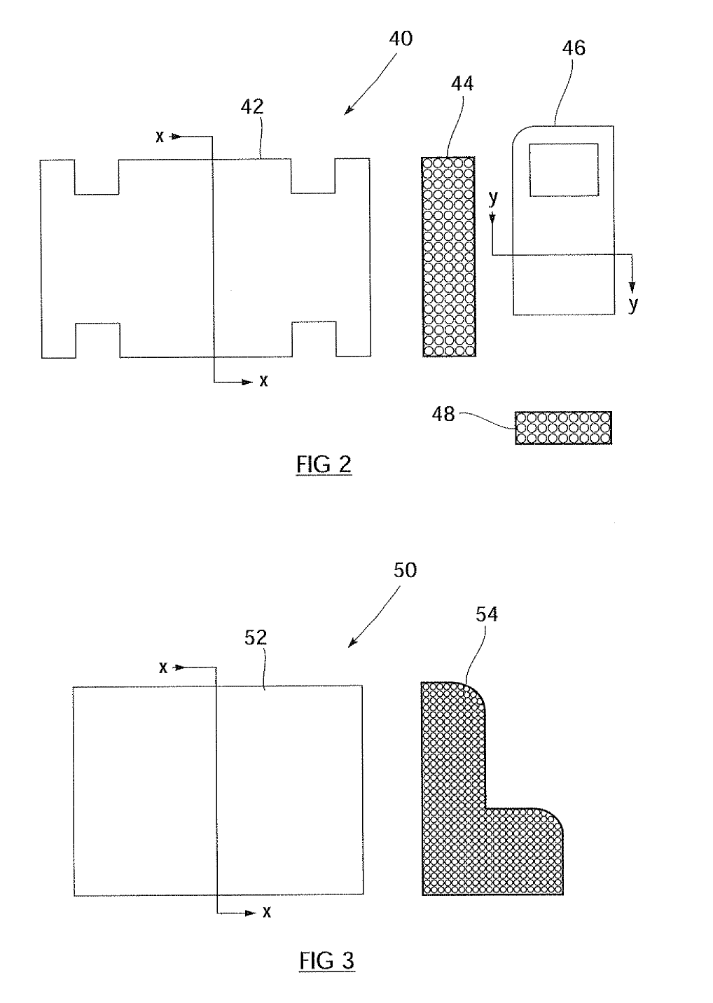

Referring now to FIG. 2 of the drawings, the arrangement 22 and 28 of FIG. 1 is shown in more detail as generally indicated by numeral 40, particularly a sectional side view 48 of a door 46 of the vehicle and a sectional view 44 of the chassis 42 of the vehicle, an interior of the door 46 and chassis 42 comprising a compressed air arrangement as hereinbefore described shaped and dimensioned to take the form and occupy the interior of the door 46 and chassis 42. At section x-x of a chassis 42 of the vehicle, the collective tubes of the core of the arrangement can be seen at 44. At section y-y of the door 46, the flexuous tubing of the arrangement can be seen as cross-section 48.

In FIG. 3 of the drawings, the arrangement 20 of FIG. 1 is shown in more detail as generally indicated by numeral 50, particularly a sectional side view 54 of a seat 52 of the vehicle taken at x-x. An interior of the seat 52 is shown comprising an arrangement as hereinbefore described shaped and dimensioned to take the form of and occupy the interior of the seat 52.

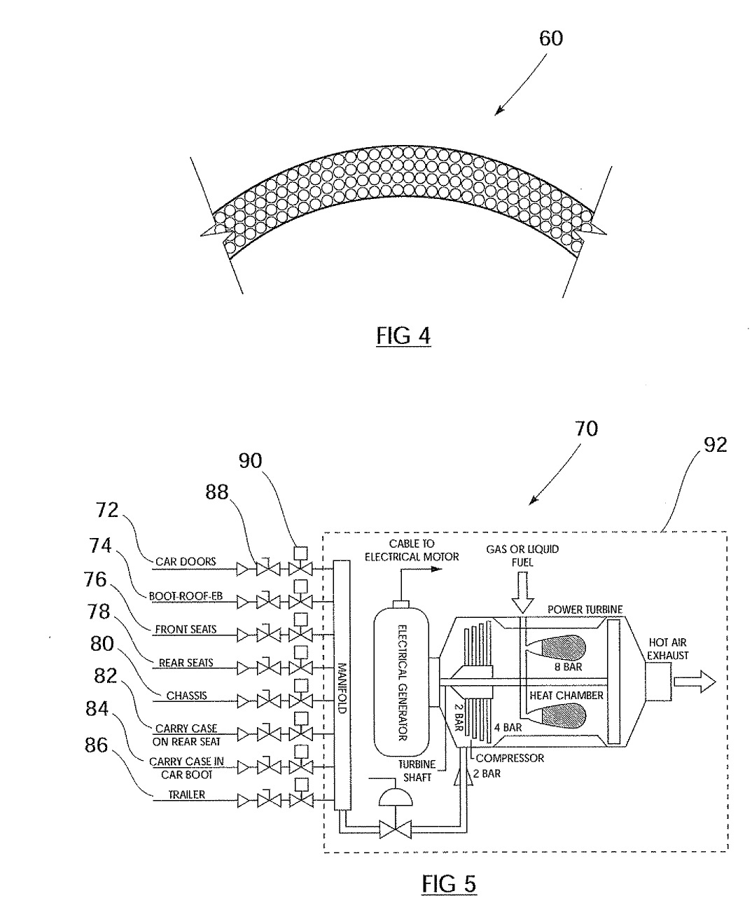

Numeral 60 of FIG. 4 shows another embodiment of a compressed air storage arrangement wherein the arrangement is shaped and dimensioned according to an interior of the vehicle engine bonnet.

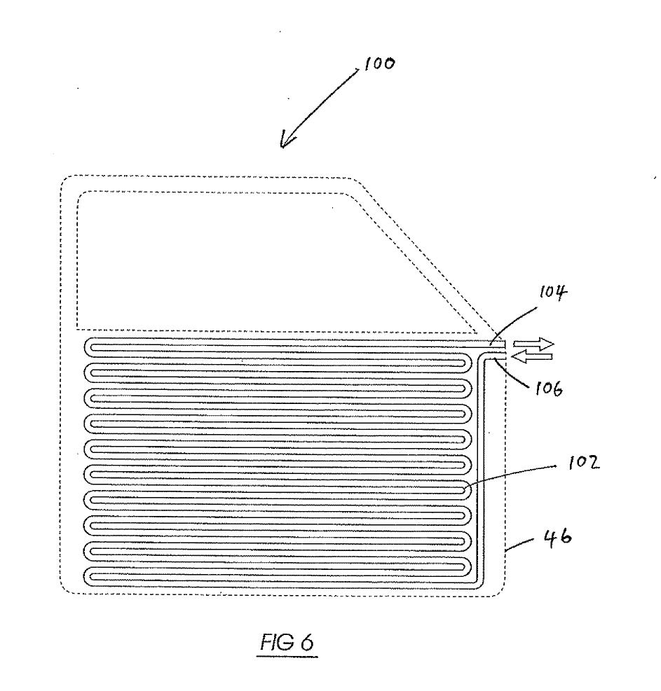

Referring now to FIG. 5 of the drawings, a compressed fluid reticulation installation as described is installed on a jet-engine type vehicle and denoted by numeral 70. The engine manifold 26 of FIG. 1 and accompanying engine is shown in broken line by 92 for illustrative purposes only. In the figure, numerals 72 through 86 represent various embodiments of a compressed air storage arrangement (some of which have been covered in FIGS. 2 through 4). The control means of the embodiments are shown, of which one is marked as 90. The installation conveniently includes isolation valves between the connectors of the arrangements and their solenoid valves, of which one is denoted by 88. For ease of viewing the compressed fluid reticulation installation of FIG. 5, the compressor air supply to the engine manifold has been omitted.

Referring to FIG. 6 of the drawings, the compressed fluid storage arrangement of FIG. 2 is shown according to another embodiment of the invention and indicated generally by numeral 100. The arrangement includes a core of flexuous tubing 102 for holding compressed air to be supplied to the motor of the vehicle, the core being shaped and dimensioned to occupy and fit an interior of the door of the vehicle 46. In this embodiment, the ends of the tube 104 and 106 define a single opening for fluidly connecting the core 102 to the supply line of the engine via a T-piece connector (not shown) for permitting both introduction of compressed fluid into the core and delivery of compressed fluid to the engine.

Advantageously, a compressed fluid storage arrangement and a compressed fluid reticulation installation for a compressed air vehicle as hereinbefore described allows for a substantially larger volume of compressed air to be stored compared to conventional compressed air tanks used in compressed air vehicles, typically 1000 litres or more. As a result of the high surface area compared to the volume of each of the plurality of tubes of the arrangements, the compressed air may be stored at 600 bar compared to a 300 bar pressure limit on conventional pressure tanks. As a result, the vehicle's travel range is dramatically increased. Further, storage of compressed air in such an installation isolates areas of storage so that a potential leak in one arrangement does not jeopardise the compressed air contents of the other arrangements. The applicant further believes that the invention as hereinbefore described provides an economical advantage over the costly use of running compressors when topping up vehicles at filling stations. Large compressed air storage vessels using such a storage arrangement would be able to store air at 800 bar, thereby allowing vehicles to be topped up quicker and eliminate the use of multiple small compressors.

It will be appreciated that the compressed air may be stored in tubing or porous material manufactured from any material which tubing is suitably flexible and porous material which is suitably rigid. It is an intention of the invention that the tubing, alternately the porous storage material, which may be stored in the cavities of vehicles or containers and be used to propel various types of vehicles, namely land, air and water vehicles. These include bicycles, motor cycles, motor cars, air craft water craft, trains, trams and trucks.

The claims and summary of invention form an integral aspect of the description of the invention.

1-16. (canceled)

17. A compressed fluid storage arrangement for a compressed fluid vehicle which includes a core of flexuous tubing for storing compressed fluid to be supplied to a motor of the vehicle, the core being shaped and dimensioned to occupy a cavity of a vehicle component.

18. The compressed fluid storage arrangement as claimed in claim 17, comprising a core of flexuous tubing has a surface area relative to its volume for safely storing fluid at, at least 450 bar of pressure; wherein an end of the tubing defining a first opening for fluidly connecting the core to a compressed fluid supply line of an engine of the motor vehicle, thereby enabling compressed fluid being passed into the core, alternately enabling the delivery of compressed fluid to the engine, in use.

19. The compressed fluid storage arrangement as claimed in claim 18, wherein the vehicle component may comprise any one of a passenger compartment; a luggage compartment; and an engine compartment, a sealed body part such as a roof, a boot lid, or an engine bonnet; a seat; a chassis; and a door.

20. The compressed fluid storage arrangement as claimed in claim 18, wherein the vehicle component may comprise a secondary vehicle which is fluidly connected to the vehicle to enable transfer of compressed fluid thereto, in use.

21. The compressed fluid storage arrangement as claimed in claim 18, wherein the arrangement comprises a fluid pressure control system for controlling the fluid pressure of the core of flexuous tubing, the fluid pressure control system having a minimum fluid pressure level and a maximum fluid pressure level, the system being configured, in use, to automatically permit inlet fluid flow into the core via the first opening until the maximum pressure level is reached, whereafter the inlet fluid flow is terminated, and to automatically permit delivery of compressed fluid via the first opening to the motor of the compressed fluid vehicle until the minimum pressure level is reached.

22. The fluid pressure control system as claimed in claim 21, wherein a control means is mounted at the first opening for controlling fluid flow into the flexuous tubing of the core.

23. The fluid pressure control system as claimed in claim 22, wherein the control means includes a control valve for controlling inlet fluid flow and outlet fluid flow to and from the tubing of the core.

24. The compressed fluid storage arrangement as claimed in claim 18, wherein the first opening comprises a connector mounted at the at least one end of the tubing for connecting the arrangement to the compressed fluid supply line of the engine; and a re-fuelling connector for connecting the supply line to an external compressor.

25. The compressed fluid storage arrangement as claimed in claim 21, wherein the first opening comprises a connector mounted at the at least one end of the tubing for connecting the arrangement to the compressed fluid supply line of the engine; and a re-fuelling connector for connecting the supply line to an external compressor.

26. The compressed fluid storage arrangement as claimed in claim 18, wherein a second opening defined by at least another end of the tubing for permitting introduction of compressed fluid to the core of the arrangement, whereby the second opening is configured to define an inlet opening for compressed fluid flow into the tubing and the first opening is configured to define an outlet opening for permitting compressed fluid flow to the supply line of the engine of the motor vehicle.

27. The compressed fluid storage arrangement as claimed in claim 21, wherein a second opening defined by at least another end of the tubing for permitting introduction of compressed fluid to the core of the arrangement, whereby the second opening is configured to define an inlet opening for compressed fluid flow into the tubing and the first opening is configured to define an outlet opening for permitting compressed fluid flow to the supply line of the engine of the motor vehicle.

28. The compressed fluid storage arrangement as claimed in claim 17, wherein the flexuous tubing is made of flexible nylon material which is configured and composed to leak fluid at pressures below its bursting pressure.

29. The compressed fluid storage arrangement as claimed in claim 17, wherein the storage arrangement is releasably securable to the vehicle.

30. The compressed fluid storage arrangement as claimed in claim 17, wherein core at least partially comprises a porous material capable of storing compresses fluid for supply to the engine.

31. The compressed fluid storage arrangement as claimed in claim 17, wherein a plurality of storage arrangements are fluidly connected.

32. The compressed fluid storage arrangement as claimed in claim 31, comprising a fluid pressure control system for controlling the fluid pressure of the cores of the arrangements to automatically permit inlet fluid flow into the cores of the fluidly connected arrangements via the supply line of the engine until one or more maximum pressures within the arrangements are reached, alternately to allow delivery of pressurised fluid to the supply line of the engine until one or more minimum pressures within the arrangements are reached.

33. The fluid pressure control system as claimed in claim 32 enabled to determine the fluid pressure in any one of the arrangements and thereby effect a continuous flow of pressurised fluid from the fluid reticulation installation to the engine of the vehicle.
